(19) United States
(12) Patent Application Publication
(10) Pub. No.: US 2010/0049903 A1
(43) Pub. Date: Feb. 25, 2010

(54) RECORDING SYSTEM AND DATA RECORDING METHOD

(76) Inventors: Chih-Jen Chin, Taipei City (TW); Sheng-Yuan Tsai, Taipei City (TW)

Correspondence Address: BRIAN M. MCINNIS, 12th Floor, Ruttonjee House, 11 Duddell Street, Hong Kong, HK

(21) Appl. No.: 12/258,832

(22) Filed: Oct. 27, 2008

(30) Foreign Application Priority Data
Aug. 21, 2008 (TW) 97131976

(51) Int. Cl. G06F 12/02

(52) U.S. Cl. 711/103; 711/E12.008

(57) ABSTRACT

A recording method for writing data into an electrically erasable programmable read-only memory is disclosed, in which the memory has already been electrically connected to a controller through a logic device. The method sets the logic devices for the first time to disconnect the memory from the controller, and set the logic devices for the second time to write setting data required by the controller into the memory. After that, the method reads out the setting data stored in the memory to confirm the writing of the setting data, and connects the memory to the controller again.

### RELATED APPLICATIONS

This application claims priority to Taiwan Application Serial Number 97131976, filed Aug. 21, 2008, which is herein incorporated by reference.

### BACKGROUND

1. Field of Invention

The present invention relates to a recording method. More particularly, the present invention relates to recording method for writing data into the memory disposed on a motherboard.

2. Description of Related Art

Electrically Erasable Programmable Read-Only Memory (EEPROM) is a non-volatile memory. Similar to the erase-read-only memory (EPROM), the information stored in the EEPROM still exists when the power is off. Electronic signals are used instead of ultraviolet radiation to eliminate data stored in the EEPROM. The non-volatile memory in the remote TV controller used by most consumers is usually implemented with EEPROM.

EEPROM has four operating modes: read mode, write mode, erase mode, and checking mode. The EEPROM requires a low voltage (typically 5 V) to perform read operations, while write operations require a high voltage (General +25 V). When EEPROM performs erase operations, high voltage is used instead of ultraviolet light to erase the contents of the designated address. With the outstanding performance and the convenient on-line operation, the EEPROM has been widely used in chips requiring frequent updates.

However, when the EEPROM has been disposed on the printed circuit board and electrically connected to the controller, data can't be updated to the EEPROM easily. The EEPROM needs to be un-welded and put on particular recorder for recording; or the update data is written to another EEPROM, and the EEPROM with old data is replaced with the updated one, which is time-consuming, troublesome, and a waste of costs.

Therefore, there is a need for a new recording method and system to simplify and cost down the recording process.

### SUMMARY

According to one embodiment of the present invention, a recording method for writing data into an electrically erasable programmable read-only memory is disclosed, in which the memory has already been electrically connected to a controller through a logic device. The method sets the logic devices for the first time to disconnect the memory from the controller, and set the logic devices for the second time to write setting data required by the controller into the memory. After that, the method reads out the setting data stored in the memory to confirm the writing of the setting data, and connects the memory to the controller again.

A recording system is disclosed in another embodiment of the present invention. According to the embodiment, the recording system includes a motherboard, an electrically erasable programmable read-only memory, a first controller, and a logic device.

The read-only memory is disposed on the motherboard. The first controller, electrically connected to the read-only memory, reads data form the read-only memory. The logic device, electrically connected between the read-only memory and the first controller, controlling the connection between the read-only memory and the first controller, in which the logic device has disconnected the read-only memory from the first controller before data is recorded to the read-only memory.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the recording system block diagram in one embodiment of the present invention;

FIG. 2 shows the recording system block diagram according to another embodiment of the present invention; and

FIG. 3 shows the recording method flow chart according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The data recording method and recording system of the following embodiment can make the controller stop accessing the Electrically Erasable Programmable Read-Only Memory (EEPROM) when the EEPROM needs to update the setting data stored therein. Therefore, setting data can be recorded into the EEPROM even when the EEPROM has been installed on the motherboard and electrically connected with the controller.

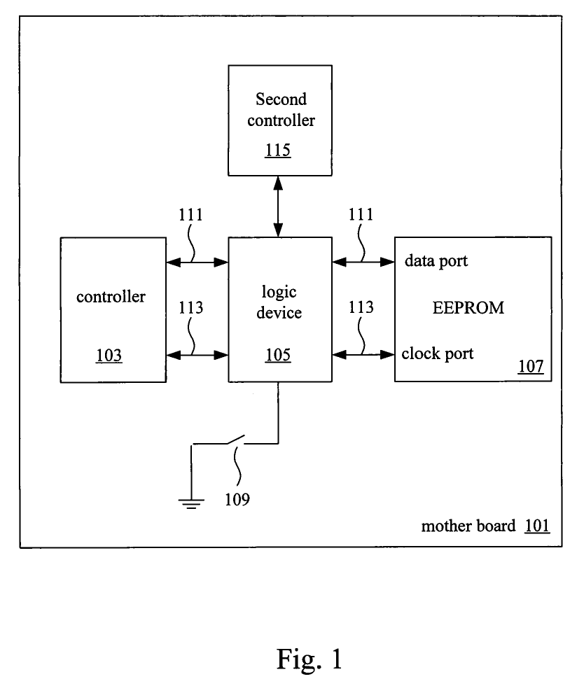

FIG. 1 shows the recording system block diagram in one embodiment of the present invention. The recording system includes the motherboard 101, the Electrically Erasable Programmable Read-Only Memory (EEPROM) 107, the controller 103, and the logic devices 105. The EEPROM 107 is disposed on the motherboard 101. The controller 103, electrically connected to the EEPROM 107 through the logic device 105, reads out the information stored in the EEPROM 107 with the clock signal 113 and the data signal 111 in order to perform its own function. For example, if the controller 103 is used for linking to the network such as the internet, the EEPROM 107 stores the configuration information for linking, such as data link layer (MAC) data, the user accounts, user passwords, dial-up Internet access or wireless Internet access, Ethernet point-to-point agreement (PPPoE), Internet protocol (IP) and so on.

The logic device 105, electrically connected between the EEPROM 107 and the controller 103, stores the recording procedure or programs, and controls the data recording process to write data into the EEPROM 107.

In another way, the recording procedure can also be stored in the second controller 115 in which case the second controller 115 administers the recording process. In this case, the second controller 115 is electrically connected to the logic devices 105 to set the logic device 105 in order to disconnect the link between the controller 103 and the EEPROM 107 when setting data is supposed to be updated into the EEPROM.

The EEPROM 107 is recorded and accessed through the clock signal 113 and the data signal 111. However, when the controller 103 is powered with supply voltage (such as 3.3 v), the controller 103 occupies the clock signal 113 and the data signal 111 such that the EEPROM 107 can't be accessed at the same time as the lack of a clock signal 113 and the data signal 111. Therefore, the connection between the controller 103 and the EEPROM 107 needs to be disconnected before recording data into the EEPROM 107.

The recording system further includes the switch circuit 109 which is electrically connected to the logic devices 105. When the switch circuit 109 connects the logic devices 105 to the ground, the logic devices 105 disconnects the controller 103 from the EEPROM 107.

Because the EEPROM 107 can't perform the recording process and be accessed by the controller 107 at the same time, the switch circuit 109 sets the logic device 105 to disconnect the EEPROM 107 from the controller 107, then a probe is taken to contacts the data port of the EEPROM 107 to record data into the EEPROM 107.

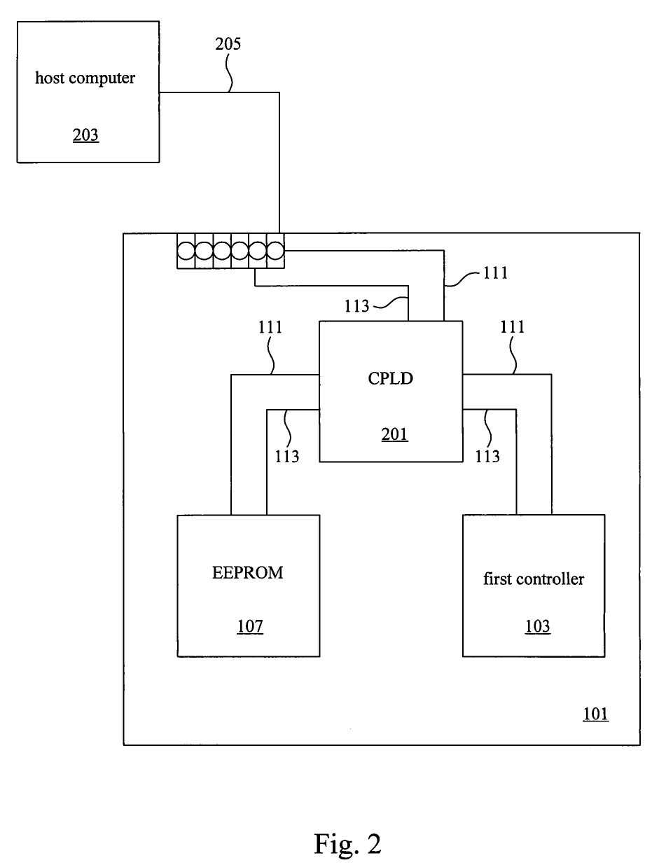

FIG. 2 shows the recording system block diagram according to another embodiment of the present invention. In addition to the motherboard 101, the EEPROM 107, the first controller 103 and the complex programmable logic devices (CPLD) 201, the recording system also includes the host computer 203. The host computer 203 has LPT/COM port 205 electrically connected to the CPLD 201 to control the CPLD 201. In this embodiment, the recording program or procedure is stored in the host computer 203 and executed by the host computer 203. When host computer 203 executes the recording program to write data into the EEPROM 107, the host computer 203 sets the CPLD 201 to disconnect the first controller 103 from the EEPROM 107 in first, and writes data into the EEPROM 107 next.

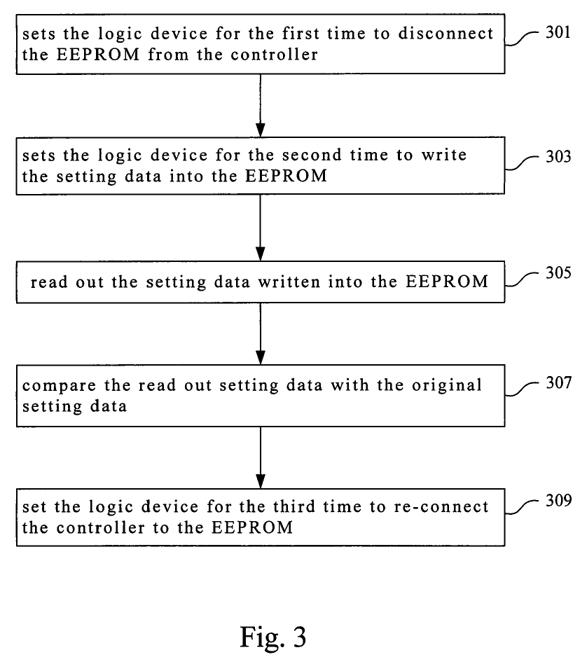

FIG. 3 shows the recording method flow chart according to one embodiment of the present invention. The method can record data into the EEPROM which has been electrically connected to the controller. The method first sets the logic device for the first time in order to disconnect the EEPROM from the controller (step 301). For example, the method can disable the controller from accessing the EEPROM by powering off the controller.

After step 301, the method sets the logic device for the second time to write setting data into the EEPROM (step 303). There are various way to write the setting data into the EEPROM. For example, the data pin of the EEPROM can be touched with a probe for writing the setting data into the EEPROM directly; the method can also save the setting data into the logic device serially (save one bit once a time), then move the setting data from the logic device into the EEPROM parallel (move several bits once a time); the host computer can also transmit the setting data from its LPT/COM port to the EEPROM through the logic device.

After step 303, the setting data written to the EEPROM is read out (step 305) and compared with the original setting data (step 307). To make sure that the setting data has been recorded to the EEPROM correctly, the setting data stored in the EEPROM needs to be read out and verified, if the comparing result shows errors, the recording process is re-executed again. There are many ways to verify the setting data stored in the EEPROM. For example, the checksum of the stored setting data and the original setting data are calculated and compared to identify if the recording process is correct.

After the comparing is finished, the method continues to set the logic device for the third time (step 309) in order to re-connect the controller to the EEPROM. After that, the controller can access the EEPROM to acquire the setting data stored therein, such as the configuration information, to perform the function.

According to the above embodiment, the recording method and the recording method can disable the controller from accessing the EEPROM, therefore, even if the EEPROM has been disposed on the substrate and connected to the controller, the setting data stored in the EEPROM can still be updated with new setting data. Such that, there is no need to remove the EEPROM disposed on the motherboard in order to update the setting data; there is no need to take another EEPROM to update the setting data, too, which save the time and cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A recording method for writing data into an electrically erasable programmable read-only memory which has already been electrically connected to a controller through a logic device, the method comprising:
setting the logic devices for the first time to disconnect the memory from the controller;
setting the logic devices for the second time to write setting data required by the controller into the memory;
reading out the setting data stored in the memory to confirm the writing of the setting data; and
setting the logic devices for the third time to connect the memory to the controller.

2. The recording method of claim 1, wherein the setting data is inputted to the logic devices serially and moved from the logic devices to the memory in parallel after the memory has been disconnected from the controller.

3. The recording method of claim 1, wherein the setting data is inputted to the logic devices with a probe contacting to a data pin of the memory after the memory has been disconnected from the controller.

4. The recording method of claim 1, wherein checksum of the read out setting data and the checksum of the original setting data are calculated and compared to each other to identify the writing of the setting data.

5. A recording system, comprising:
a motherboard;
an electrically erasable programmable read-only memory disposed on the motherboard;
a first controller, electrically connected to the read-only memory, reading data form the read-only memory; and
a logic device, electrically connected between the read-only memory and the first controller, controlling the connection between the read-only memory and the first controller, wherein the logic device has disconnected the read-only memory from the first controller before data is recorded to the read-only memory.

6. The recording system of claim 5, further comprising a switch circuit electrically connected to the logic device for setting the logic device, wherein the switch circuit connects the logic device to a ground for disconnecting the read-only memory form the first controller.

7. The recording system of claim 5, further comprising a host computer electrically connected to the logic device, wherein the host computer sets the logic device to disconnect the memory from the first controller, and sets the logic device for recording data to the read-only memory.

8. The recording system of claim 5, further comprising a second controller setting the logic device for writing data into the read-only memory.

9. The recording system of claim 5, wherein the logic device is a complex programmable logic device.

10. The recording system of claim 5, wherein the first controller is a networking chip for connecting Internet, and the read-only memory stores data required by the networking chip for connecting Internet.
